(19) United States
(12) Patent Application Publication
(10) Pub. No.: US 2009/0013091 A1
(43) Pub. Date: Jan. 8, 2009

(54) CUSTOMER BASED MESSAGE ROUTING

(75) Inventors: Yi Zhang, Bothell, WA (US); Chi H. Tang, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/773,102

(22) Filed: Jul. 3, 2007

(51) Int. Cl. G06F 15/173

(52) U.S. Cl. 709/242

(57) ABSTRACT

A method and system for messaging, and more particularly archiving of messages in a distributed network of archiver nodes, by routing and grouping of the messages by customer, utilizing traditional recipient email addresses in SMTP is disclosed.

### TECHNICAL FIELD

The technical field relates generally the routing and grouping of the messages, and more particularly to the archiving of messages in a distributed network of archiver nodes.

### BACKGROUND

Traditional archiving services for messages utilized a server node to which incoming messages were routed and stored for backup and protection against database, memory, and other failures. Such servers took the incoming messages and stored them, usually in the order in which they were received, and stored them sequentially in the storage medium. Such storage routines would mix messages from different sources, from different customers, and with different storage requirements. Over time, the memory size, database connections, and volume of the received and stored, archived messages tended to increase, becoming problematic regarding sorting, organizing, and maintaining the stored received messages.

Improvements regarding distributed archiving networks that utilize archiver nodes, now permit almost continuous distributed archiving of messages, but have additional issues.

Some of the additional issues include the effects of having numerous customers' archived files and messages located on a single archiver node. This topology creates additional database connections and larger memory requirements, and does not scale adequately, as the network and number of customers and archived messages grow over time.

An additional issue is that when the archiver node has difficulty with archive messages from one customer (for example due to a customer database failure, burst messages from the customer or other problem), the archiving processes for all other customers slow in response. When this occurs, the entire network performance may degrade, message queue length may become longer, and message archiving latency will become significantly longer than normal. This problem with a single customer's data, may impact other customers of the archive system and archiver node.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

Messages are routed based on the customer involved with a message. Additionally, the customer based message routing runs on top of, or substantially transparently with, traditional recipient email address based routing, such as with SMTP. Further included is the mapping of customer based message routing into SMTP. Grouping of messages and customers are utilized in one embodiment, such that a particular customer's messages for archiving may be directed to specific archiver nodes, based on a generated address and/or header.

In one embodiment, a method is utilized for routing a message. The method includes receiving a plurality of messages; assigning at least one group number to each one of the plurality of the received messages, wherein the at least one group number is assigned in accordance with at least one attribute of the respective received message; generating at least one routing address in accordance with the assigned group numbers; associating each received message with a respective generated routing address generating a respective header routing address; routing a received message to a storage facility in accordance with the generated header routing address; and storing each received message in a respective storage facility.

Advantageously, problems with a single customer's archiving service and messages, are prevented from impacting other customer's archiving services. Message traffic is partitioned according to customers, and deposits such messages on a designated archiver node. By balancing archiver node utilization between the customers based on an assigned group, improvements in performance are created.

Additionally, routing of messages can be based on customers involved with a message, such as email messages.

Further, customer based message routing can occur on top of traditional recipient email address based routing systems, for example through SMTP.

### BRIEF DESCRIPTION OF THE DRAWINGS

The foregoing summary, as well as the following detailed description, is better understood when read in conjunction with the appended drawings. For the purpose of illustrating customer based message routing, there is shown in the drawings exemplary constructions thereof; however, customer based message routing is not limited to the specific methods and instrumentalities disclosed.

FIG. 1 is a table regarding sample data showing customer identifiers (Numbers) paired with email domain addresses.

FIG. 2 is a table regarding the sample data showing customer identifiers (numbers) paired with generated group numbers.

FIG. 3 is an example message sender and receiver list, for an example message.

FIG. 4 is an example of a generated new MIME header for the sample message.

FIG. 5 is a sample message sender and receiver list, for the generated routing addresses including the newly created addresses.

FIG. 6 is an example routing table useful in a customer based message routing network.

FIG. 7 is a flow diagram of one embodiment for utilizing example data for descriptive purposes.

FIG. 8 is a block diagram of an example processor via which customer based message routing can be implemented.

FIG. 9 is a depiction of a suitable computing environment in which customer based message routing can be implemented.

### DETAILED DESCRIPTION OF ILLUSTRATIVE EMBODIMENTS

Traditional style email routing and other message routing may occur through the use of SMTP, which includes message routing based on a recipient address. Mail messages such as typical email messages, may include multiple recipients, and such initial message is or may be split into multiple messages at some time during transportation. This multiple messaging usually occurs when the message routing table indicates more than one next hop required for message delivery.

Customer based message routing is based on a routing scheme that is dependent on the customers with whom the message involves. If multiple customers are involved, then the message can also be split into multiple messages along the way to the message's destination, and in an example embodiment, in a distributed archiving network, to an archiver node or nodes.

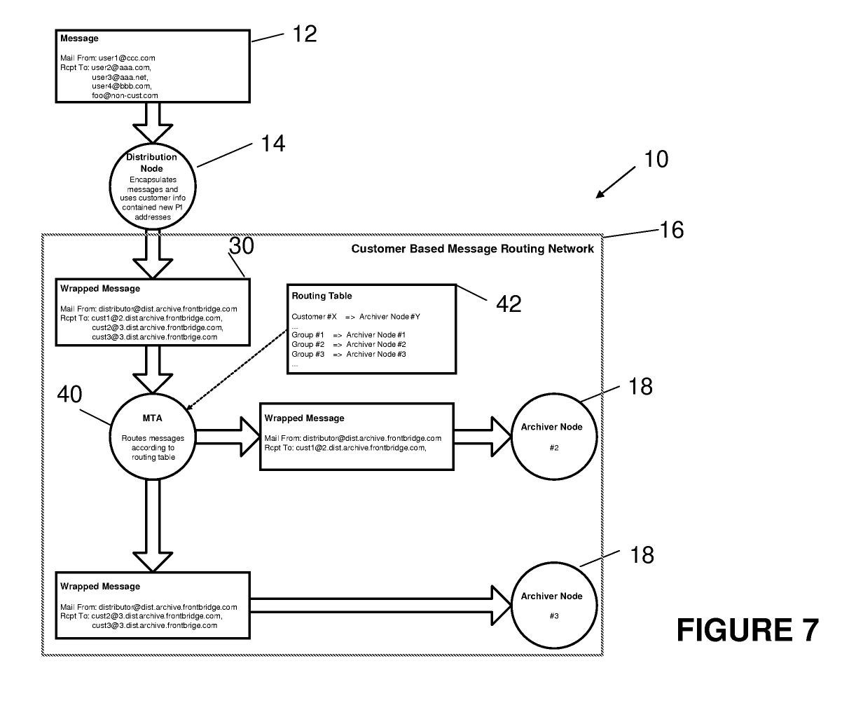

FIG. 7 is a flow diagram of an example process and system 10 for utilizing example data for descriptive purposes. The example process, as depicted in FIG. 7, takes received messages 12, and, through the use of a customer table (that assigns a customer to a group), generates copies of the received messages and adds on, encapsulates, or “wraps” one or more new generated routing addresses to the message copy (14), then sends such reformed message to a dedicated archiving system network 16 or archiver node 18. Such system utilizes standard SMTP protocol and MTA (Message Transfer Agents) to forward and accept such received message with the new generated routing address. For clarity sake, it is the new generated routing address (based on the assigned customer group) that permits the new function of organizing messages of certain customers via groups, to a particular archiver node.

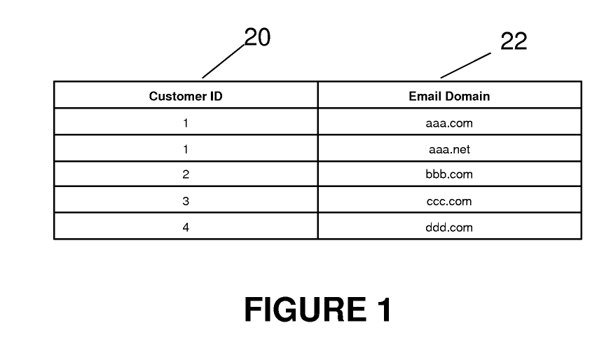

FIG. 1 shows such a META-database table comprising customer ID numbers 20 corresponding to the customer's corresponding email domains 22 for which archival services can be utilized. A separate database table pairing the Customer IDs 20, with the actual customer names may also be in existence to facilitate correspondence from Customer name to Customer ID. FIG. 1 shows three example customers and their associated email domains. For ease of description, each customer will have a unique tag or identifier, and in this description, a Customer ID 20 or number, although other tokens, indicia, or characters may be utilized to uniquely identify a customer for use with the system, and particularly in a distributed archiving system.

Now to balance the eventual load of the messages as archived between the plurality of archiver nodes, customers are grouped in groups, the various groups assigned by various schemes, one preferred scheme to be described herein. For ease of description, such groups shall be identified by a unique group number, but as used in this application, almost any uniquely identifying name, indicia, or token could be used equivalently as a group number, as long as the message passing system or protocol utilized would permit its use.

For most efficient archiver node utilization, customers are placed into groups, such that each group will have roughly equal numbers of archive messages per day. Small to midsize customers can be grouped into a single group, while larger customers (with more messages to archive) could be grouped in to a group all by themselves (that is a group of one). For best total archive system throughput, archival messages for one group will be routed to the same archiver node. Other system constraints can place more than one group on to an archiver node.

The method of assigning a customer to a group, can include 1) obtaining the total number of archived messages in a period of time (such as one week), for each customer; assigning the sum as a weight to the respective customer, then 2) sorting the list of weights and customers in descending order of their weight. If there are possibly N number of virtual buckets (the buckets equal to the number of archiver nodes), then 3) sequentially assigning customers from the sorted list to the N number of virtual buckets, in a way that the current customer to be assigned is always moved into the bucket containing least weight, while preferably and at the same time trying to minimize the total number of customers in each bucket.

Other ways of assigning customers to groups are possible such as by message volume over the last 60 days, message traffic volume of similar received messages, or initially only assigning one customer to a bucket or group. At least one attribute of the received messages is useful in determining which customer will be assigned to a group.

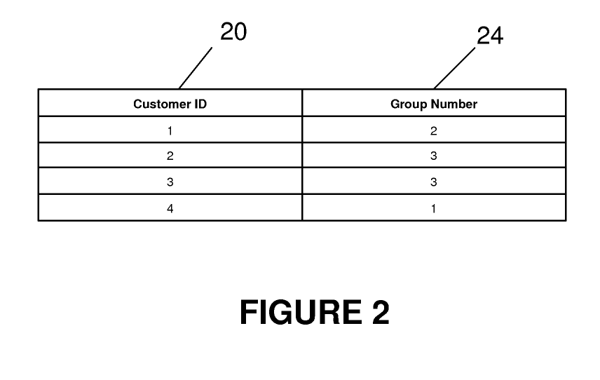

In an example embodiment, customers are assigned such that a minimum count of customers is in a group. These groups are used for addressing the ultimate archiver node to which the customer archival messages are passed and stored. By having customer's archival services separated ultimately by archiver node, single point problems or errors with the archiver node are prevented from affecting more than the group of customers assigned to such archiver node. All of the rest of the archiver nodes and customer archival services are not therefore affected if an archiver node cannot communicate effectively with the network. FIG. 2 shows a possible database table showing an assignment of customers (via customer ID 20) to group numbers 24, in this case four customers to three groups.

With the customer email domains assigned to a customer, and customers assigned to a group, incoming messages are converted such that they can be routed based on the customers or attributes involved with the message.

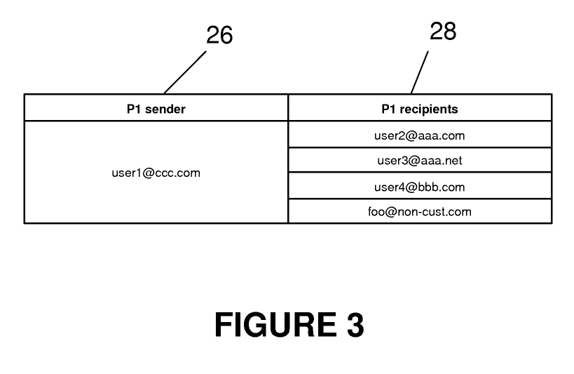

FIG. 3 depicts an example message sender block 26 and receiver block 28 for a message. Email domains of the message (both sender and receiver) are collected from the message and corresponding customer IDs 20 are found via a lookup function into the table of FIG. 1. For example, a group number 24 (FIG. 2), or in this case group numbers 24 are assigned via a lookup of the corresponding customer IDs 20. In the present example in FIG. 3, the last and bottom message receiver --foo@non-cust.com--, is not a customer in our example.

In an example embodiment, at least one group number is assigned to each of the received plurality of messages, and in this case the group number 24 is assigned in accordance with one attribute of the respective received message, that is for example, if a customer ID can be associated with a sender or receiver email domain. In our example, more than one group number 24 is assigned, as there is more than one customer of archival services associated with the message.

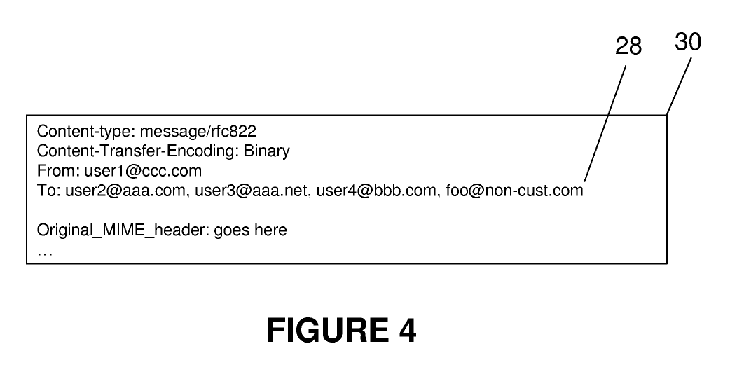

The received message 12 is encapsulated, “wrapped”, or more clearly associated with a new generated routing address and respective header routing address. The original MIME of the received message is encapsulated in a new generated MIME header 30. This new MIME header 30 contains the original envelope sender and recipients (P1 Sender and Recipients from FIG. 3), as found in FIG. 4, for example. Thus the original MIME (of the received message) becomes the payload or body of the new MIME format message 30.

The generated routing addresses use the assigned groups and customers previously identified for the received message, and can be formed in a routing table. Such generation creates at least one new routing address in accordance with the at least one group number assigned to the received message. An example rule for constructing the new recipients of the message to be archived, using the assigned group number 22 and customer ID 20, could be:
Cust[Customer ID]@[group number].a_dedicated_domain

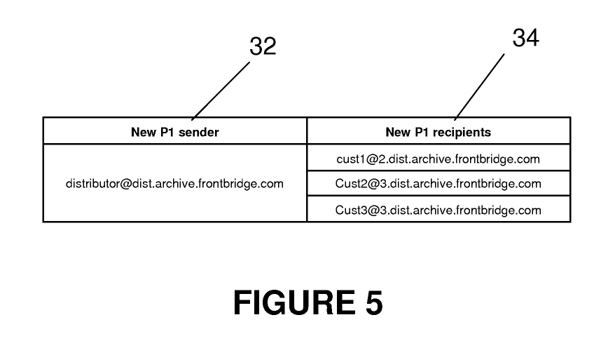

In the example as shown in FIG. 5, the dedicated domain is “dist.archive.frontbridge.com”. The new generated routing address (in table format) is shown in FIG. 5, where the new P1 sender 32 is a name to indicate that the original message has been wrapped or associated (the distributor, as in a distributor node 14, for example), and new P1 recipients are the generated routing addresses from the assigned groups and customers. Thus, the previous customer email message recipients or (others customers associated with the message) have had their address transformed into a format that can now be utilized to directly send the message to a designated archiver node 18 (FIG. 7).

The original received message is routed to a storage facility (archiver node 18) in accordance with the generated header routing address and is stored in the respective storage facility.

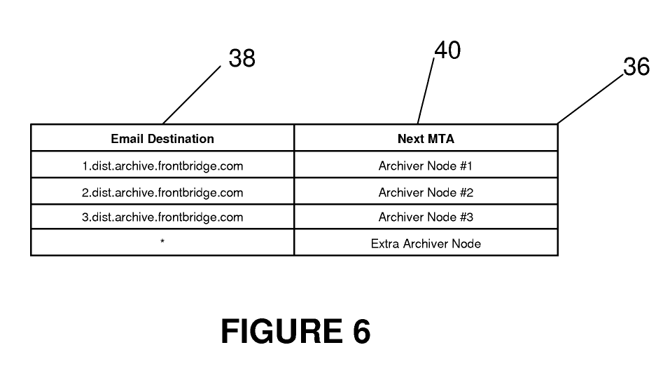

As shown in FIG. 6, there is developed a routing table 36 in the archiver node per the example, with the different email designations 38, now domains indicating a particular group, associated with the next Message Transport Agent (MTA) 40, and in this case particular, selected archiver nodes 18. In an example embodiment, the system and generated routing addresses are SMTP compliant.

After the archiver node 18 receives the new message 30, it archives the message into databases of the customers listed on the New P1 recipients 34. FIG. 7 shows generally the flow of received messages 12, along with an alternate routing table 42 that more directly shows the association of a particular group to that of a respective, particular archiver node 18.

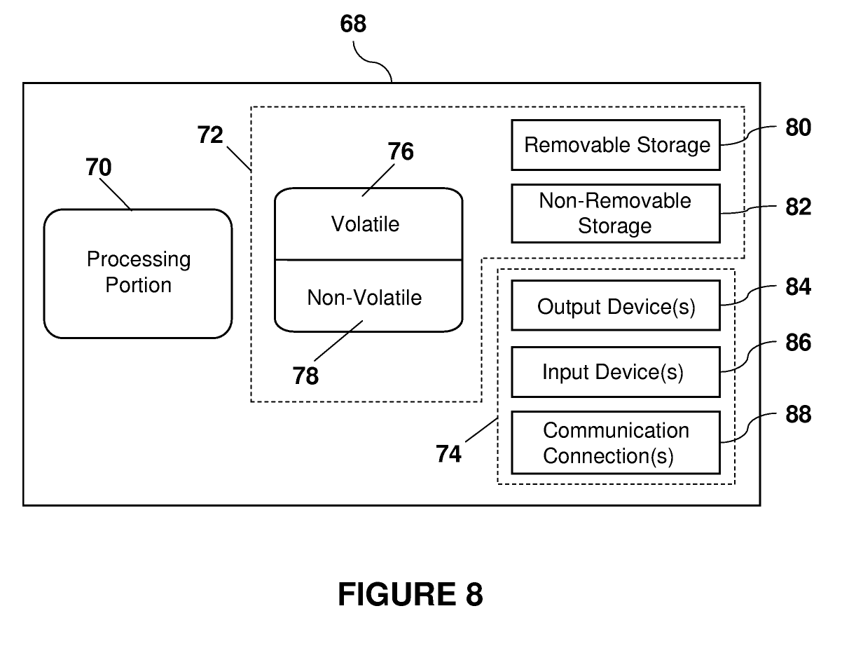

FIG. 8 is a diagram of an exemplary processor 68 for implementing customer based message routing, including nodes and agents. The processor 68 comprises a processing portion 70, a memory portion 72, and an input/output portion 74. The processing portion 70, memory portion 72, and input/output portion 74 are coupled together (coupling not shown in FIG. 8) to allow communications therebetween. The input/output portion 74 is capable of providing and/or receiving components utilized to perform customer based message routing as described above. For example, the input/output portion 74 is capable of receiving a message, providing each received message to a memory portion in accordance a header routing address, or a combination thereof. The processing portion 70 is capable of implementing customer based message routing as described above. For example, the procession portion 70 is capable of assigning a group number to each one of a plurality of the received messages, assigning the group number in accordance with an attribute of a respective received message, generating a routing address in accordance with an assigned group number, associating a received message with a respective generated routing address, generating a respective header routing address, or a combination thereof.

The processor 68 can be implemented as a client processor and/or a server processor. In a basic configuration, the processor 68 can include at least one processing portion 70 and memory portion 72. The memory portion 72 can store any information utilized in conjunction with customer based message routing. Depending upon the exact configuration and type of processor, the memory portion 72 can be volatile (such as RAM) 76, non-volatile (such as ROM, flash memory, etc.) 78, or a combination thereof. The processor 68 can have additional features/functionality. For example, the processor 68 can include additional storage (removable storage 80 and/or non-removable storage 82) including, but not limited to, magnetic or optical disks, tape, flash, smart cards or a combination thereof. Computer storage media, such as memory portion 72, 76, 78, 80, and 82, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 68. Any such computer storage media can be part of the processor 68.

The processor 68 can also contain communications connection(s) 88 that allow the processor 68 to communicate with other devices, such as other servers, distributor nodes, archive nodes, MTAs, or most particularly computer systems forwarding messages, for example. Communications connection(s) 88 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor 68 also can have input device(s) 86 such as keyboard, mouse, pen, voice input device, touch input device, etc. Output device(s) 84 such as a display, speakers, printer, etc. also can be included.

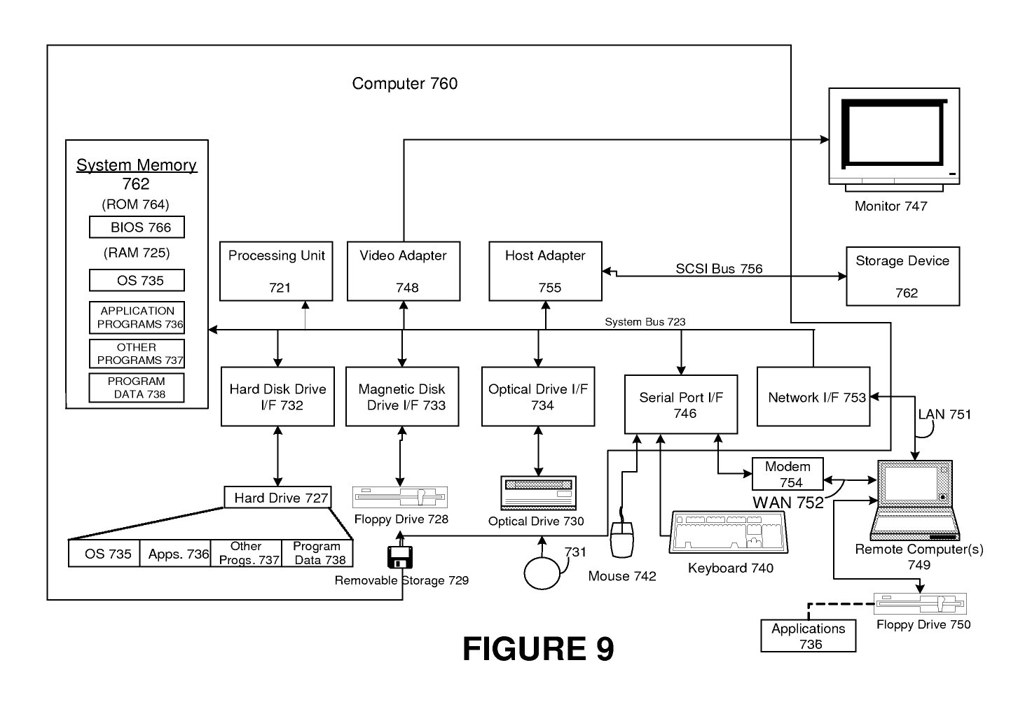

FIG. 9 and the following discussion provide a brief general description of a suitable computing environment in which customer based message routing can be implemented. Although not required, various aspects of customer based message routing can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, implementation of customer based message routing can be practiced with other computer system configurations, including hand held devices, multi processor systems, microprocessor based or programmable consumer electronics, network PCs, minicomputers, mainframe computers, and the like. Further, customer based message routing also can be practiced in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 721, the memory (both ROM 764 and RAM 725), the basic input/output system (BIOS) 766, and various input/output (I/O) devices such as a keyboard 740, a mouse 762, a monitor 747, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with customer based message routing as described above.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 9, an exemplary general purpose computing system includes a conventional computing device 760 or the like, including a processing unit 721, a system memory 762, and a system bus 723 that couples various system components including the system memory to the processing unit 721. The system bus 723 may be any of several types of bus structures including a memory bus or memory controller, a peripheral bus, and a local bus using any of a variety of bus architectures. The system memory includes read only memory (ROM) 764 and random access memory (RAM) 725. A basic input/output system 766 (BIOS), containing basic routines that help to transfer information between elements within the computing device 760, such as during start up, is stored in ROM 764. The computing device 760 may further include a hard disk drive 727 for reading from and writing to a hard disk (hard disk not shown), a magnetic disk drive 728 (e.g., floppy drive) for reading from or writing to a removable magnetic disk 729 (e.g., floppy disk, removal storage), and an optical disk drive 730 for reading from or writing to a removable optical disk 731 such as a CD ROM or other optical media. The hard disk drive 727, magnetic disk drive 728, and optical disk drive 730 are connected to the system bus 723 by a hard disk drive interface 732, a magnetic disk drive interface 733, and an optical drive interface 734, respectively. The drives and their associated computer readable media provide non volatile storage of computer readable instructions, data structures, program modules and other data for the computing device 760. Although the exemplary environment described herein employs a hard disk, a removable magnetic disk 729, and a removable optical disk 731, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 729, optical disk 731, ROM 764, or RAM 725, including an operating system 735, one or more application programs 736, other program modules 737, and program data 738. A user may enter commands and information into the computing device 760 through input devices such as a keyboard 740 and pointing device 762 (e.g., mouse). Other input devices (not shown) may include a microphone, joystick, game pad, satellite disk, scanner, or the like. These and other input devices are often connected to the processing unit 721 through a serial port interface 746 that is coupled to the system bus, but may be connected by other interfaces, such as a parallel port, game port, or universal serial bus (USB). A monitor 747 or other type of display device is also connected to the system bus 723 via an interface, such as a video adapter 748. In addition to the monitor 747, computing devices typically include other peripheral output devices (not shown), such as speakers and printers. The exemplary environment of FIG. 9 also includes a host adapter 755, Small Computer System Interface (SCSI) bus 756, and an external storage device 762 connected to the SCSI bus 756.

The computing device 760 may operate in a networked environment using logical connections to one or more remote computers, such as a remote computer 749. The remote computer 749 may be another computing device (e.g., personal computer), a server, a router, a network PC, a peer device, or other common network node, and typically includes many or all of the elements described above relative to the computing device 760, although only a memory storage device 750 (floppy drive) has been illustrated in FIG. 9. The logical connections depicted in FIG. 9 include a local area network (LAN) 751 and a wide area network (WAN) 752. Such networking environments are commonplace in offices, enterprise wide computer networks, intranets and the Internet.

When used in a LAN networking environment, the computing device 760 is connected to the LAN 751 through a network interface or adapter 753. When used in a WAN networking environment, the computing device 760 can include a modem 754 or other means for establishing communications over the wide area network 752, such as the Internet. The modem 754, which may be internal or external, is connected to the system bus 723 via the serial port interface 746. In a networked environment, program modules depicted relative to the computing device 760, or portions thereof, may be stored in the remote memory storage device. It will be appreciated that the network connections shown are exemplary and other means of establishing a communications link between the computers may be used.

While it is envisioned that numerous embodiments of customer based message routing are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for customer based message routing, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for implementing customer based message routing.

The program(s) can be implemented in assembly or machine language, if desired, and may be written in Perl to run on the Linux Operating system. In any case, the language can be a compiled or interpreted language, and combined with hardware implementations. The methods and apparatuses for implementing customer based message routing also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like. When implemented on a general-purpose processor, the program code combines with the processor to provide a unique apparatus that operates to invoke the functionality of customer based message routing. Additionally, any storage techniques used in connection with customer based message routing can invariably be a combination of hardware and software.

While customer based message routing has been described in connection with the example embodiments of the various figures, it is to be understood that other similar embodiments can be used or modifications and additions can be made to the described embodiments for performing the same functions of customer based message routing without deviating therefrom. Therefore, customer based message routing as described herein should not be limited to any single embodiment, but rather should be construed in breadth and scope in accordance with the appended claims.

What is claimed:

1. A method for routing a message, the method comprising:
receiving a plurality of messages;
assigning at least one group number to each one of the plurality of the received messages, wherein said at least one group number is assigned in accordance with at least one attribute of the respective received message;
generating at least one routing address in accordance with the assigned group number;
associating each received message with a respective generated routing address generating a respective header routing address;
routing a received message to a storage facility in accordance with the generated header routing address; and
storing each received message in a respective storage facility.

2. The method in accordance with claim 1, wherein the assigning step assigns a group number to a particular message such that said at least one attribute of the received messages is substantially equivalent among all of the groups.

3. The method in accordance with claim 2, wherein said at least one attribute of the received message comprises message traffic volume of similar received messages.

4. The method in accordance with claim 1, wherein the assigning step assigns a group number to a particular message wherein said at least one attribute of the received message comprises at least one of a sender and a recipient of a respective message.

5. The method in accordance with claim 1, wherein said assigning step assigns a group number to a particular message depending on the domain associated with at least one of a sender and recipient of a respective message.

6. The method in accordance with claim 1, wherein the generating at least one routing address step comprises generating a routing table.

7. The method in accordance with claim 1, wherein said assigning step assigns a group number to a particular message depending on a customer associated with at least one of the sender and recipient of a respective message.

8. The method in accordance with claim 1, wherein said storage facility comprises an archiver node.

9. A system for routing a message, the system comprising:
an input/output portion configured to:
receive a plurality of messages; and
provide each received message to a memory portion in accordance with at least one header routing address; and
a processing portion configured to:
assign at least one group number to each one of the plurality of the received messages, wherein the group number is assigned in accordance with at least one attribute of the respective received message
generate at least one routing address in accordance with the assigned at least one group number; and
associate each received message with a respective generated routing address
generate a respective header routing address.

10. The system of claim 9, further comprising a memory portion configured to store received messages.

11. The system of claim 9, further comprising a distribution node configured to encapsulate the received messages.

12. The system of claim 9, further comprising a mail transfer agent configured to route messages according to said generated routing address.

13. The system of claim 9, in which said respective header routing address is SMTP compliant.

14. A computer-readable storage medium having computer-executable instructions for routing a message in connection with a computer, by performing steps of:
receiving a plurality of messages;
assigning at least one group number to each one of the plurality of the received messages, wherein said at least one group number is assigned in accordance with at least one attribute of the respective received message;
generating at least one routing address in accordance with the assigned group number;
associating each received message with a respective generated routing address generating a respective header routing address;
routing a received message to a storage facility in accordance with the generated header routing address; and
storing each received message in a respective storage facility.

15. A computer-readable medium in accordance with claim 14, wherein the assigning step assigns a group number to a particular message such that said at least one attribute of the received messages is substantially equivalent among all of the groups.

16. A computer-readable medium in accordance with claim 15 wherein said at least one attribute of the received message is message traffic volume of similar received messages.

17. A computer-readable medium in accordance with claim 14, wherein the assigning step assigns a group number to a particular message wherein said at least one attribute of the received message comprises at least one of a sender and a recipient of a respective message.

18. A computer-readable medium in accordance with claim 14, wherein said assigning step assigns a group number to a particular message depending on the domain associated with at least one of a sender and recipient of a respective message.

19. A computer-readable medium in accordance with claim 14, wherein the generating at least one routing address step comprises generating a routing table.

20. A computer-readable medium in accordance with claim 14, wherein said assigning step assigns a group number to a particular message depending on a customer associated with at least one of the sender and recipient of a respective message.
